(19) United States
(12) Patent Application Publication
(10) Pub. No.: US 2026/0229598 A1
(43) Pub. Date: Aug. 6, 2026

(54) LITHIUM-ION BATTERY

(71) Applicant: ZHUHAI COSMX BATTERY CO., LTD., Zhuhai (CN)

(72) Inventors: Yingdi MU, Zhuhai (CN); Long WANG, Zhuhai (CN); Hai WANG, Zhuhai (CN); Suli LI, Zhuhai (CN)

(73) Assignee: ZHUHAI COSMX BATTERY CO., LTD., Zhuhai (CN)

(21) Appl. No.: 19/633,913

(22) Filed: Mar. 30, 2026

Related U.S. Application Data
(63) Continuation of application No. 18/146,032, filed on Dec. 23, 2022, now Pat. No. 12,609,356.
Application No. 18/146,032 is a continuation of application No. PCT/CN2021/135477, filed on Dec. 3, 2021.

(30) Foreign Application Priority Data
Dec. 3, 2020 (CN) 202011396207.7

(51) Int. Cl. H01M 10/0567; H01M 4/02; H01M 4/36; H01M 4/38; H01M 4/583; H01M 10/0525; H01M 10/0568; H01M 10/0569

(52) U.S. Cl. CPC H01M 10/0567; H01M 4/364; H01M 4/386; H01M 4/583; H01M 10/0525; H01M 10/0568; H01M 10/0569; H01M 2004/027; H01M 2300/0028

(57) ABSTRACT

A lithium-ion battery includes a positive electrode plate, a negative electrode plate, a separator and an electrolyte; the electrolyte includes an organic solvent, an additive and a lithium salt. The additive includes fluoroethylene carbonate, accounts for 9 wt % to 20 wt %; the additive further includes at least one of succinonitrile, adiponitrile, glycerol trinitrile, 1,3,6-hexanetricarbonitrile, and 1,2-bis(cyanoethoxy) ethane, and a content thereof accounts for 1 wt % to 5 wt % of a total mass of the electrolyte; the negative electrode plate includes a negative electrode active material, and the negative electrode active material includes a silicon-carbon negative electrode material including nano-silicon and/or SiOₓ(0.8≤x≤1.3) and graphite. One or more of the nano-silicon and SiOₓ account for 1 wt % to 55 wt % of a total mass of the silicon-carbon negative electrode material.

### CROSS-REFERENCE TO RELATED APPLICATIONS

The present application is a continuation of U.S. patent application Ser. No. 18/146,032, filed on Dec. 23, 2022, which is a continuation of International Application No. PCT/CN2021/135477, filed on Dec. 3, 2021, which claims priority to Chinese Patent Application No. 202011396207.7, filed on Dec. 3, 2020. All of the afore-mentioned patent applications are hereby incorporated by reference in their entireties.

### TECHNICAL FIELD

The present disclosure belongs to the technical field of lithium-ion batteries, and specifically relates to a lithium-ion battery.

### BACKGROUND

Since commercialization of lithium-ion batteries, the lithium-ion batteries have been widely used in fields such as the digital field, the energy storage field, the power field, the military aerospace field, and the field of communications devices due to high specific energy and good cycling performance. With the wide application of the lithium-ion batteries, consumers constantly improve use environments and demands for the lithium-ion batteries, and have increasingly high requirements for battery lives of electronic devices. This requires the lithium-ion batteries to have relatively high energy density, in addition to high-temperature performance and low-temperature performance.

### SUMMARY

The present disclosure provides a lithium-ion battery, which may effectively alleviate problems of large battery cycle expansion, short cycle life, and failing to implement both high-temperature performance and low-temperature performance of a battery and the like, thereby significantly improving high-temperature/low-temperature performance, prolonging a cycle life and safety performance of the lithium-ion battery, so that the lithium-ion battery is suitable for large-scale commercial production.

Specifically, the present disclosure provides the following technical solutions.

The present disclosure further provides a lithium-ion battery. The lithium-ion battery includes a positive electrode plate, a negative electrode plate, a separator, and the foregoing electrolyte.

Further, the lithium-ion battery is a lithium-ion battery of a silicon-carbon system.

Further, the negative electrode plate includes a negative electrode current collector and a negative electrode active material layer applied to a surface of either or both sides of the negative electrode current collector. The negative electrode active material layer includes a negative electrode active material, and the negative electrode active material includes a silicon-carbon negative electrode material including nano-silicon and/or SiOₓ (0.8≤x≤1.3).

In some embodiments, one or more of the nano-silicon and SiOₓ account for 1 wt % to 55 wt % of a total mass of the silicon-carbon negative electrode material, for example, 1 wt %, 2 wt %, 5 wt %, 8 wt %, 10 wt %, 12 wt %, 15 wt %, 18 wt %, 20 wt %, 25 wt %, 30 wt %, 35 wt %, 40 wt %, 45 wt %, 50 wt %, or 55 wt %.

In some embodiments, the negative electrode active material layer further includes a first binder, a first conductive agent, and a dispersing agent.

In some embodiments, the negative electrode active material layer includes components of the following mass percentage: 70 wt % to 99.7 wt % of the negative electrode active material, 0.1 wt % to 10 wt % of the first binder, 0.1 wt % to 10 wt % of the dispersing agent, and 0.1 wt % to 10 wt % of the first conductive agent.

In some embodiments, the negative electrode active material layer includes components of the following mass percentage: 76 wt % to 98.5 wt % of the negative electrode active material, 0.5 wt % to 8 wt % of the first binder, 0.5 wt % to 8 wt % of the dispersing agent, and 0.5 wt % to 8 wt % of the first conductive agent.

In some embodiments, the negative electrode active material layer includes components of the following mass percentage: 85 wt % to 98.5 wt % of the negative electrode active material, 0.5 wt % to 5 wt % of the first binder, 0.5 wt % to 5 wt % of the dispersing agent, and 0.5 wt % to 5 wt % of the first conductive agent.

In some embodiments, the first binder is selected from at least one of high molecular polymers such as polyvinylidene fluoride (PVDF), polytetrafluoroethylene (PTFE), polyethyleneimine (PEI), polyaniline (PAN), polyacrylic acid (PAA), sodium alginate, styrene-butadiene rubber (SBR), sodium carboxymethyl cellulose (CMC), phenolic resin, or epoxy resin.

In some embodiments, the dispersing agent is selected from at least one of polyvinyl alcohol (PVA), cetyl ammonium bromide, sodium dodecyl benzene sulfonate, silane coupling agent, ethanol, N-methyl pyrrolidone (NMP), N,N-dimethyl formamide (DMF), and the like, more preferably, at least one of cetyl ammonium bromide, sodium dodecyl benzene sulfonate, silane coupling agent, and ethanol.

In some embodiments, the first conductive agent is selected from at least one of carbon nanotubes (CNTs), carbon fibers (VGCF), conductive graphite (KS-6 and SFG-6), mesocarbon microbeads (MCMB), graphene, Ketjen black, Super P, acetylene black, conductive carbon black, or hard carbon.

In some embodiments, the positive electrode plate includes a positive electrode current collector and a positive electrode active material layer applied to a surface of either or both sides of the positive electrode current collector. The positive electrode active material layer includes a positive electrode active material, and the positive electrode active material is selected from one or more of LiCoO₂, LiNiO₂, LiMn₂O₄, LiFePO₄, and LiₓNi_{y}M_{1-y}O₂, where 0.9≤x≤1.2, 0.5≤y<1, and M is selected from one or more of Co, Mn, Al, Mg, Ti, Zr, Fe, Cr, Mo, Cu, and Ca.

In some embodiments, the positive electrode active material layer further includes a second binder and a second conductive agent.

In some embodiments, the positive electrode active material layer includes components of the following mass percentage: 80 wt % to 99.8 wt % of the positive electrode active material, 0.1 wt % to 10 wt % of the second binder, and 0.1 wt % to 10 wt % of the second conductive agent.

In some embodiments, the positive electrode active material layer includes components of the following mass percentage: 84 wt % to 99 wt % of the positive electrode active material, 0.5 wt % to 8 wt % of the second binder, and 0.5 wt % to 8 wt % of the second conductive agent.

In some embodiments, the positive electrode active material layer includes components of the following mass percentage: 90 wt % to 99 wt % of the positive electrode active material, 0.5 wt % to 5 wt % of the second binder, and 0.5 wt % to 5 wt % of the second conductive agent.

In some embodiments, the second binder is selected from at least one of high molecular polymers such as polyvinylidene fluoride (PVDF), polytetrafluoroethylene (PTFE), polyethyleneimine (PEI), polyaniline (PAN), polyacrylic acid (PAA), sodium alginate, styrene-butadiene rubber (SBR), sodium carboxymethyl cellulose (CMC), phenolic resin, or epoxy resin.

In some embodiments, the second conductive agent is selected from at least one of carbon nanotubes (CNTs), carbon fibers (VGCF), conductive graphite (KS-6 and SFG-6), mesocarbon microbeads (MCMB), graphene, Ketjen black, Super P, acetylene black, conductive carbon black, or hard carbon.

In some embodiments, the separator is a separator known in the art, such as a polyethylene separator, a polypropylene separator, or the like.

The electrolyte includes an organic solvent, an additive, and a lithium salt. The additive includes fluoroethylene carbonate.

In some embodiments, a content of fluoroethylene carbonate accounts for 8 wt % to 20 wt % of a total mass of the electrolyte, for example, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %.

Fluoroethylene carbonate (English name: fluoroethylene carbonate; and CAS number: 114435-02-8) in the present disclosure may be prepared according to a method known in the art, or purchased through a commercial channel.

In some embodiments, the additive further includes lithium trifluoromethyl triethyl borate and prop-1-ene-1,3-sultone.

In some embodiments, a content of lithium trifluoromethyl triethyl borate accounts for 0.1 wt % to 2 wt % of a total mass of the electrolyte, preferably 0.2 wt % to 1.0 wt %, and more preferably 0.2 wt % to 0.5 wt %, for example, 0.1 wt %, 0.2 wt %, 0.3 wt %, 0.4 wt %, 0.5 wt %, 0.8 wt %, 0.9 wt %, 1 wt %, 1.2 wt %, 1.3 wt %, 1.4 wt %, 1.5 wt %, 1.6 wt %, 1.7 wt %, 1.8 wt %, 1.9 wt %, or 2.0 wt %.

Lithium trifluoromethyl triethyl borate in the present disclosure may be prepared according to a method known in the art, or purchased through a commercial channel.

In some embodiments, a structure of lithium trifluoromethyl triethyl borate in the present disclosure is represented by formula 1:

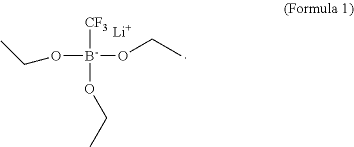

In some embodiments, a content of prop-1-ene-1,3-sultone accounts for 0.2 wt % to 3.5 wt % of a total mass of the electrolyte, preferably 0.5 wt % to 2 wt %, for example, 0.2 wt %, 0.3 wt %, 0.4 wt %, 0.5 wt %, 0.8 wt %, 0.9 wt %, 1 wt %, 1.2 wt %, 1.3 wt %, 1.4 wt %, 1.5 wt %, 1.6 wt %, 1.7 wt %, 1.8 wt %, 1.9 wt %, 2.0 wt %, 3.0 wt %, or 3.5 wt %.

Prop-1-ene-1,3-sultone (English name: prop-1-ene-1,3-sultone; and Chemical Abstracts Service (CAS) number: 21806-61-1) in the present disclosure may be prepared according to a method known in the art, or purchased through a commercial channel.

In some embodiments, the additive further includes at least one of succinonitrile, adiponitrile, glycerol trinitrile, 1,3,6-hexanetricarbonitrile, and 1,2-bis(cyanoethoxy) ethane, and a content thereof accounts for 0 wt % to 10 wt % of a total mass of the electrolyte, for example, may range from 1 wt % to 5 wt %.

In some embodiments, the organic solvent is selected from at least one of a carbonic ester, a carboxylic ester, and a fluoroether, where the carbonic ester is selected from a combination of one or more of ethylene carbonate, propylene carbonate, dimethyl carbonate, ethyl methyl carbonate, diethyl carbonate, and methyl propyl carbonate; the carboxylic ester is selected from a combination of one or both of ethyl propionate and propyl propionate; and the fluoroether is selected from 1,1,2,2-tetrafluoroethyl-2,2,3,3-tetrafluoropropylether.

In some embodiments, the lithium salt is selected from one or more of lithium hexafluorophosphate, lithium bisfluorosulfonylimide, or lithium bis(trifluoromethanesulphonyl)imide.

In some embodiments, a content of the lithium salt accounts for 10 wt % to 20 wt % of a total mass of the electrolyte, for example, 10 wt %, 11 wt %, 12 wt %, 13 wt %, 14 wt %, 15 wt %, 16 wt %, 17 wt %, 18 wt %, 19 wt %, or 20 wt %.

The present disclosure further provides a method for preparing an electrolyte. The method includes the following step: mixing an organic solvent, an additive, and a lithium salt, where the additive includes lithium trifluoromethyl triethyl borate, prop-1-ene-1,3-sultone, and fluoroethylene carbonate.

For example, the method includes the following steps: preparing the organic solvent in a glove box that is filled with argon gas and that has qualified water content and oxygen content; and then quickly adding the fully dried lithium salt, lithium trifluoromethyl triethyl borate, prop-1-ene-1,3-sultone, and fluoroethylene carbonate, to prepare the electrolyte.

The present disclosure further provides a method for preparing the foregoing lithium-ion battery. The method includes the following steps:
(1) preparing a positive electrode plate and a negative electrode plate, where the positive electrode plate includes a positive electrode active material, and the negative electrode plate includes a negative electrode active material;
(2) mixing an organic solvent, an additive, and a lithium salt to prepare an electrolyte; and
(3) winding the positive electrode plate, a separator, and the negative electrode plate to obtain a bare cell that has not undergone injection; placing the bare cell into outer package foil; and injecting the electrolyte obtained in step (2) into the bare cell that is dried, to prepare the lithium-ion battery.

For example, the method specifically includes the following steps.

### (1) Preparation of a Positive Electrode Plate

Mixing the positive electrode active material LiCoO₂, the binder polyvinylidene fluoride (PVDF), and the conductive agent acetylene black in a weight ratio of 96.5:2:1.5; adding N-methyl pyrrolidone (NMP) and stirring the mixture under the action of a vacuum blender until a mixed system becomes positive electrode slurry with uniform fluidity; uniformly applying the positive electrode slurry to aluminum foil with a thickness ranging from 9 μm to 12 μm; baking the foregoing well coated aluminum foil in an oven with five different temperature gradients; and drying the aluminum foil in the oven at 120° C. for 8 hours, followed by rolling and slitting, to obtain a required positive electrode plate.

### (2) Preparation of a Silicon-Carbon Negative Electrode Plate

Preparing negative electrode slurry according to a wet process from a silicon-carbon negative electrode material (composed of SiO and graphite, where a mass percentage of SiO is 3%) with a mass percentage of 95.9%, a conductive agent single-walled carbon nanotubes (SWCNT) with a mass percentage of 0.1%, a conductive agent conductive carbon black (SP) with a mass percentage of 1%, a dispersing agent sodium carboxymethyl cellulose (CMC) with a mass percentage of 1%, and a binder styrene-butadiene rubber (SBR) with a mass percentage of 2%; uniformly applying the negative electrode slurry to copper foil with a thickness ranging from 9 μm to 12 μm; baking the foregoing well coated copper foil in an oven with five different temperature gradients; and drying the copper foil in the oven at 85° C. for 5 hours, followed by rolling and slitting, to obtain a required silicon-carbon negative electrode plate.

### (3) Preparation of an Electrolyte

Uniformly mixing ethylene carbonate, propylene carbonate, propyl propionate, and ethyl propionate in a mass ratio of 1:2:5:2 (a solvent needs to be normalized) in a glove box that is filled with argon gas and that has qualified water content and oxygen content; and quickly adding 1 mol/L (12.5 wt %) of fully dried lithium hexafluorophosphate (LiPF₆) and an additive (including lithium trifluoromethyl triethyl borate, prop-1-ene-1,3-sultone, and fluoroethylene carbonate), to obtain the electrolyte.

### (4) Preparation of a Separator

Using a polyethylene separator with a thickness ranging from 7 μm to 9 μm.

### (5) Preparation of a Lithium-Ion Battery

Winding the positive electrode plate, the separator, and the negative electrode plate prepared above to obtain a bare cell that has not undergone injection; placing the bare cell into outer package foil; and injecting the prepared electrolyte into the dried bare cell, followed by processes such as vacuum packaging, standing, formation, shaping, and sorting, to obtain a required lithium-ion battery.

Through the above-mentioned solution, the lithium-ion battery has a long cycle life, high-temperature/low-temperature performance and safety performance.

### DETAILED DESCRIPTIONS OF THE EMBODIMENTS

The following further describes the present disclosure in detail with reference to specific embodiments. It should be understood that the following examples are only intended to illustrate and explain the present disclosure, and shall not be construed as a limitation on the protection scope of the present disclosure. All technologies implemented based on the foregoing content of the present disclosure shall fall within the intended protection scope of the present disclosure.

Experimental methods used in the following examples are conventional methods unless otherwise specified. Reagents, materials, and the like that are used in the following examples may be all obtained from commercial sources unless otherwise specified.

### Comparative Examples 1 to 6 and Examples 1 to 8

Lithium-ion batteries in Comparative Examples 1 to 6 and Examples 1 to 8 were all prepared according to the following preparation method, and the difference lies in selection and addition amounts of components in an electrolyte. For specific differences, refer to Table 1.

### (1) Preparation of a Positive Electrode Plate

Mixing a positive electrode active material LiCoO2, a binder polyvinylidene fluoride (PVDF), and a conductive agent acetylene black in a weight ratio of 96.5:2:1.5; adding N-methyl pyrrolidone (NMP) and stirring the mixture under the action of a vacuum blender until a mixed system becomes positive electrode slurry with uniform fluidity; uniformly applying the positive electrode slurry to aluminum foil with a thickness ranging from 9 μm to 12 μm; baking the foregoing well coated aluminum foil in an oven with five different temperature gradients; and drying the aluminum foil in the oven at 120° C. for 8 hours, followed by rolling and slitting, to obtain a required positive electrode plate.

### (2) Preparation of a Silicon-Carbon Negative Electrode Plate

Preparing negative electrode slurry according to a wet process from a silicon-carbon negative electrode material (composed of SiO and graphite, where a mass percentage of SiO is 3%) with a mass percentage of 95.9%, a conductive agent single-walled carbon nanotubes (SWCNT) with a mass percentage of 0.1%, a conductive agent conductive carbon black (SP) with a mass percentage of 1%, a dispersing agent sodium carboxymethyl cellulose (CMC) with a mass percentage of 1%, and a binder styrene-butadiene rubber (SBR) with a mass percentage of 2%; uniformly applying the negative electrode slurry to copper foil with a thickness ranging from 9 μm to 12 μm; baking the foregoing well coated copper foil in an oven with five different temperature gradients; and drying the copper foil in the oven at 85° C. for 5 hours, followed by rolling and slitting, to obtain a required silicon-carbon negative electrode plate.

### (3) Preparation of an Electrolyte

Uniformly mixing ethylene carbonate, propylene carbonate, propyl propionate, and ethyl propionate in a mass ratio of 1:2:5:2 (the solvent needs to be normalized) in a glove box that is filled with argon gas and that has qualified water content and oxygen content; and quickly adding 1 mol/L (12.5 wt %) of fully dried lithium hexafluorophosphate (LiPF6), 3 wt % of mass percentage of 1,3,6-hexanetricarbonitrile, and other additive (including lithium trifluoromethyl triethyl borate, prop-1-ene-1,3-sultone, and fluoroethylene carbonate, where for specific content and selection, refer to Table 1) to the mixture, to obtain the electrolyte.

### (4) Preparation of a Separator

Using a polyethylene separator with a thickness ranging from 7 μm to 9 μm.

### (5) Preparation of a Lithium-Ion Battery

Winding the positive electrode plate, the separator, and the negative electrode plate prepared above to obtain a bare cell that has not undergone injection; placing the bare cell into outer package foil; and injecting the prepared electrolyte into the dried bare cell, followed by processes such as vacuum packaging, standing, formation, shaping, and sorting, to obtain a required lithium-ion battery.

TABLE 1
Composition and adding amounts of other additives
in the electrolyte in step (3) in
Comparative Examples 1 to 6 and Examples 1 to 8

| | Adding amount | | |
|---|---|---|---|
| | of lithium | Adding | Adding |
| | trifluoromethyl | amount of | amount of |
| | triethyl borate | prop-1-ene-1,3- | fluoroethylene |
| Item | (wt %) | sultone (wt %) | carbonate (wt %) |
| Comparative | 0.5 | / | / |
| Example 1 | | | |
| Comparative | / | 0.5 | / |
| Example 2 | | | |
| Comparative | / | / | 8.0 |
| Example 3 | | | |
| Comparative | 0.5 | 0.5 | / |
| Example 4 | | | |
| Comparative | 0.5 | / | 8.0 |
| Example 5 | | | |
| Comparative | / | 0.5 | 8.0 |
| Example 6 | | | |
| Example 1 | 0.5 | 0.5 | 8.0 |
| Example 2 | 0.1 | 2.0 | 10.0 |
| Example 3 | 1.0 | 1.5 | 12.0 |
| Example 4 | 1.5 | 2.5 | 15.0 |
| Example 5 | 2.0 | 0.2 | 9.0 |
| Example 6 | 0.8 | 3.5 | 18.0 |
| Example 7 | 1.2 | 3.0 | 20.0 |
| Example 8 | 1.4 | 2.8 | 14.0 |

Electrochemical performance of batteries obtained in the foregoing comparative examples and examples was tested, and related descriptions are as follows:

### (1) 45° C. Cyclic Experiment:

The batteries obtained in the foregoing examples and comparative examples were placed in an environment of (45±2° C.), followed by standing for 2-3 hours; when battery bodies reached (45±2° C.), the batteries underwent 1C constant-current charge with a cut-off current of 0.05C until the batteries were fully charged, followed by standing for 5 minutes; and then the batteries underwent 0.7C constant-current discharge with a cut-off voltage of 3.0 V, where the highest discharge capacity of the first three cycles was recorded as an initial capacity Q, an initial thickness T of each battery cell was recorded, and when the cycles reached a required quantity of times, a discharge capacity Q₁ and a battery thickness T₁ of each battery in the last cycle were recorded. The recorded results are shown in Table 2.

The following calculation formulas were used:

$$Capacity retention ( \% ) = {Q}_{1} / Q \times 100 \% ; and$$

$$Thickness change rate ( \% ) = ( {T}_{1} - T ) / T \times 100 \% .$$

(2) Experiment with 10-Hour High-Temperature Storage at 85° C.:

The batteries obtained in the foregoing examples and comparative examples were placed at room temperature to perform three times of charge/discharge cycle tests at a charge/discharge rate of 0.5C, and then charged at a rate of 0.5C to a fully charged state, where the highest discharge capacity Q2 and a battery thickness T₂ of each battery in the first three 0.5C cycles were recorded respectively. The batteries were stored at 85° C. for 10 hours after being fully charged, and after the 10 hours, a battery thickness T₃ and a 0.5C discharge capacity Q₃ were recorded. Experimental data, such as thickness change rate and capacity retention of the batteries stored at high temperature, were calculated, where recorded results are shown in Table 2.

The following calculation formulas were used:

$$Capacity retention ( \% ) = {Q}_{3} / {Q}_{2} \times 100 \% ; and$$

$$Thickness change rate ( \% ) = ( {T}_{3} - {T}_{2} ) / {T}_{2} \times 100 \% .$$

### (3) 130° C. Thermal Shock Experiment:

The batteries obtained in the foregoing examples and comparative examples were heated according to a convection method or by using a circulating hot air box at an initial temperature of (25±3° C.) with a temperature change rate of (5±2° C.)/min; and when the temperature was raised to (130±2° C.), the experiment was ended after the temperature had been kept for 60 minutes. The state results of the batteries were recorded as in Table 2.

### (4) Low-Temperature Discharge Experiment:

The batteries obtained in the foregoing examples and comparative examples were placed in an environment with a temperature of (25±3° C.) to first discharge to 3.0 V at 0.2C, and then charged at 0.7C after standing for 5 minutes; when a cell terminal voltage reached a limited charge voltage, charging was performed at a constant voltage; the charging was stopped when a charge current become less than or equal to a cut-off current, followed by standing for 5 minutes; the batteries were discharged to 3.0 V at 0.2C; and a discharge capacity in this time was recorded as a room-temperature capacity Q₄. Then, the cell is charged at 0.7C; when the cell terminal voltage reached the limited charge voltage, charging was performed at a constant voltage; the charging was stopped when the charge current become less than or equal to the cut-off current; the fully charged batteries left to stand for 4 hours at (−10±2° C.), and were discharged with a current of 0.4C to the cut-off voltage of 3.0V; and a discharge capacity Q₅ was recorded. A low-temperature discharge capacity retention may be calculated, and recorded results are shown in Table 2.

The following calculation formula was used:

$$Low - temperature discharge capacity retention ( \% ) = {Q}_{5} / {Q}_{4} \times 100 \% .$$

TABLE 2
Performance test results of Comparative Examples 1 to 6 and Examples 1 to 8

| | | | 10-hour high- | | 130° C . | | Capacity |
|---|---|---|---|---|---|---|---|
| | 500 cycles for | | temperature storage | | thermal shock | | retention |
| | 1 C at 45° C. | | at 85° C. | | for 60 minutes | | of 0.4 C |
| | Capacity | Thickness | Capacity | Thickness | Fire | Explosion | discharge |
| | retention | change | retention | change | (passes/ | (passes/ | at |
| Item | % | rate % | % | rate % | tests) | tests) | −10° C. |
| Comparative | 55.45% | 28.4% | 62.44% | 23.9% | 0/5 | 0/5 | 79.41% |
| Example 1 | | | | | | | |
| Comparative | 57.71% | 23.1% | 68.29% | 16.7% | 2/5 | 2/5 | 61.06% |
| Example 2 | | | | | | | |
| Comparative | 65.47% | 13.5% | 53.45% | 29.5% | 1/5 | 1/5 | 63.49% |
| Example 3 | | | | | | | |
| Comparative | 60.14% | 19.4% | 70.83% | 15.5% | 2/5 | 2/5 | 68.34% |
| Example 4 | | | | | | | |
| Comparative | 67.12% | 13.2% | 55.39% | 24.7% | 0/5 | 0/5 | 66.15% |
| Example 5 | | | | | | | |
| Comparative | 68.39% | 12.2% | 69.38% | 15.0% | 3/5 | 4/5 | 57.86% |
| Example 6 | | | | | | | |
| Example 1 | 73.62% | 10.8% | 74.32% | 9.8% | 5/5 | 5/5 | 74.94% |
| Example 2 | 74.34% | 9.6% | 77.49% | 8.3% | 5/5 | 5/5 | 71.34% |
| Example 3 | 75.10% | 9.0% | 75.10% | 9.3% | 5/5 | 5/5 | 74.56% |
| Example 4 | 77.62% | 8.5% | 79.18% | 7.5% | 5/5 | 5/5 | 76.71% |
| Example 5 | 73.54% | 10.3% | 70.31% | 12.9% | 5/5 | 5/5 | 79.89% |
| Example 6 | 80.40% | 7.5% | 80.21% | 5.9% | 5/5 | 5/5 | 75.19% |
| Example 7 | 82.58% | 8.5% | 79.36% | 6.8% | 5/5 | 5/5 | 77.12% |
| Example 8 | 75.38% | 10.5% | 77.48% | 7.3% | 5/5 | 5/5 | 78.33% |

The following can be learned from the results in Table 2.

In summary, the lithium-ion battery of a silicon-carbon system is enabled to have not only excellent high-temperature cycling performance, high-temperature storage performance, and low-temperature discharge performance, but also high safety performance.

The foregoing illustrates implementation of the present disclosure. However, the present disclosure is not limited to the foregoing implementation. Any modifications, equivalent replacements, improvements, or the like made without departing from the spirit and principle of the present disclosure shall fall within the protection scope of the present disclosure.

What is claimed is:

1. A lithium-ion battery, wherein the lithium-ion battery comprises a positive electrode plate, a negative electrode plate, a separator and an electrolyte; the electrolyte comprises an organic solvent, an additive and a lithium salt, the additive comprises fluoroethylene carbonate; the fluoroethylene carbonate accounts for 9 wt % to 20 wt % of a total mass of the electrolyte; the additive further comprises at least one of succinonitrile, adiponitrile, glycerol trinitrile, 1,3,6-hexanetricarbonitrile, and 1,2-bis(cyanoethoxy) ethane, and a content thereof accounts for 1 wt % to 5 wt % of a total mass of the electrolyte; and
the negative electrode plate comprises a negative electrode active material layer, the negative electrode active material layer comprises a negative electrode active material, and the negative electrode active material comprises a silicon-carbon negative electrode material comprising nano-silicon and/or SiOₓ(0.8≤x≤1.3) and graphite; one or more of the nano-silicon and SiOₓ account for 1 wt % to 55 wt % of a total mass of the silicon-carbon negative electrode material.

2. The lithium-ion battery according to claim 1, wherein the fluoroethylene carbonate accounts for 12 wt % to 20 wt % of the total mass of the electrolyte.

3. The lithium-ion battery according to claim 1, wherein the fluoroethylene carbonate accounts for 15 wt % to 20 wt % of the total mass of the electrolyte.

4. The lithium-ion battery according to claim 1, wherein the organic solvent is selected from at least one of a carbonic ester, a carboxylic ester, or a fluoroether.

5. The lithium-ion battery according to claim 4, wherein the carbonic ester is selected from a combination of one or more of ethylene carbonate, propylene carbonate, dimethyl carbonate, ethyl methyl carbonate, diethyl carbonate, or methyl propyl carbonate.

6. The lithium-ion battery according to claim 5, wherein the carbonic ester is selected from one or both of ethylene carbonate and propylene carbonate.

7. The lithium-ion battery according to claim 4, wherein the carboxylic ester is selected from a combination of one or both of ethyl propionate and propyl propionate.

8. The lithium-ion battery according to claim 4, wherein the fluoroether is selected from 1,1,2,2-tetrafluoroethyl-2,2,3,3-tetrafluoropropylether.

9. The lithium-ion battery according to claim 4, wherein the lithium salt is selected from one or more of lithium hexafluorophosphate, lithium bisfluorosulfonylimide, or lithium bis(trifluoromethanesulphonyl)imide.

10. The lithium-ion battery according to claim 9, wherein a content of the lithium salt accounts for 10 wt % to 20 wt % of a total mass of the electrolyte.

11. The lithium-ion battery according to claim 1, wherein the negative electrode active material layer further comprises a first binder, a first conductive agent and a dispersing agent; and/or,
the positive electrode plate comprises a positive electrode active material layer, and the positive electrode active material layer comprises a positive electrode active material, a second binder and a second conductive agent.

12. The lithium-ion battery according to claim 11, wherein the first binder and the second binder are independently selected from at least one of high molecular polymers such as polyvinylidene fluoride (PVDF), polytetrafluoroethylene (PTFE), polyethyleneimine (PEI), polyaniline (PAN), polyacrylic acid (PAA), sodium alginate, styrene-butadiene rubber (SBR), sodium carboxymethyl cellulose (CMC), phenolic resin, or epoxy resin.

13. The lithium-ion battery according to claim 11, wherein the first conductive agent and the second conductive agent are independently selected from at least one of carbon nanotubes (CNTs), carbon fibers (VGCF), conductive graphite (KS-6 and SFG-6), mesocarbon microbeads (MCMB), graphene, Ketjen black, Super P, acetylene black, conductive carbon black, or hard carbon.

14. The lithium-ion battery according to claim 11, wherein the positive electrode active material is selected from one or more of LiCoO₂, LiNiO₂, LiMn₂O₄, LiFePO₄, and LiₓNi_{y}M_{1-y}O₂, where 0.9≤x≤1.2, 0.5≤y<1, and M is selected from one or more of Co, Mn, Al, Mg, Ti, Zr, Fe, Cr, Mo, Cu, and Ca.
